(19) United States
(12) Patent Application Publication
(10) Pub. No.: US 2022/0041837 A1
(43) Pub. Date: Feb. 10, 2022

(54) FLUOROPOLYMER COMPOSITION STABILIZED AGAINST CHANGES IN PH

(71) Applicant: SOLVAY SPECIALTY POLYMERS ITALY S.P.A., Bollate (IT)

(72) Inventors: Serena CARELLA, Parabiago (IT); Mirko MAZZOLA, Milano (IT); Giulio BRINATI, Milano (IT)

(21) Appl. No.: 16/762,914

(22) PCT Filed: Nov. 22, 2018
(86) PCT No.: PCT/EP2018/082148

§ 371 Date: May 8, 2020

(30) Foreign Application Priority Data
Nov. 24, 2017 (EP) 17203480.3

(51) Int. Cl. C08K 3/26; C08F 14/22; C08K 3/28; H01M 50/446; H01M 50/489; H01M 4/62; H01G 11/52; H01G 11/50; H01G 11/48

(52) U.S. Cl. CPC C08K 3/26; C08F 14/22; C08K 3/28; H01M 50/446; H01M 50/489; H01M 4/623; H01M 2004/027; H01G 11/52; H01G 11/50; H01G 11/48; C08K 2003/262; C08K 2201/014; H01M 4/628

(57) ABSTRACT

The present invention relates to a composition comprising particles of at least one 1,1-difluoroethylene (VDF)-based fluoropolymer, in admixture with a stabilizer agent selected from alkaline metal hydrogencarbonates or hydrogenphosphates, and to uses of said composition notably in electrochemical cells.

### CROSS-REFERENCE TO RELATED APPLICATIONS

This application claims priority to European application No. 17203480.3 filed on 24 Nov. 2017, the whole content of those applications being incorporated herein by reference for all purposes.

### TECHNICAL FIELD

The present invention relates to a composition comprising at least one fluoropolymer, notably a vinylidene fluoride (VDF)-based fluoropolymer, in admixture with a stabilizer agent, and to uses of said composition notably in electrochemical cells.

### BACKGROUND ART

Vinylidene fluoride (VDF)-based polymers are typically manufactured by suspension polymerization or emulsion polymerization processes.

For instance, U.S. Pat. No. 5,283,302 (KUREHA CHEMICAL INDUSTRY CO., LTD.) Jan. 2, 1994 discloses a process for manufacturing vinylidene fluoride polymers having fine spherulites, said process being carried out by suspension polymerization in an aqueous medium, said process comprising adding a chain transfer agent when polymerization conversion rate reaches 10-50%.

U.S. Pat. No. 3,714,137 (SUEDDEUTSCHE KALKSTICKSTOFF-WEKE) Jan. 30, 1973 discloses the polymerization of vinylidene fluoride at an acidic pH and in the presence of a peroxydisulfate polymerization initiator; the pH value of the aqueous reaction medium may be adjusted by any acid which is inert to the reaction, and preferred pH range is between 4 and 6. Preferred acids are boric acid, sulfuric acid and hydrochloric acid. The preferred initiators are ammonium peroxydisulfate and potassium peroxydisulfate.

WO 2012/030784 (ARKEMA) Mar. 8, 2012 is directed to a method of producing fluoropolymers using acid-functionalized monomers; more specifically, it pertains to a process for preparing a fluoropolymer in an aqueous reaction medium, comprising:

a) forming an aqueous emulsion comprising at least one radical initiator, at least one acid-functionalized monomer or salt thereof (preferably ammonium or sodium salts), and at least one fluoromonomer, typically vinylidene fluoride, and
b) initiating polymerization of said at least one fluoromonomer. Chain-transfer agents are added to the polymerization to regulate the molecular weight of the product. They may be added to a polymerization in a single portion at the beginning of the reaction, or incrementally or continuously throughout the reaction. Buffering agents may comprise an organic or inorganic acid or alkali metal salt thereof, or base or salt of such organic or inorganic acid, that has at least one pKa value in the range of from about 4 to about 10, preferably from about 4.5 to about 9.5. Preferred buffering agents described in this document include, for example, phosphate buffers and acetate buffers.

The above mentioned patent documents disclose processes for the manufacture of fluoropolymer, wherein at least one buffering agent is added in the reaction environment during the polymerization reaction, thus providing a favourable environment for the reaction to take place.

### SUMMARY OF INVENTION

The present Applicant recognized that—although buffering agents are used in the polymerization process—the pH value of the final fluoropolymer composition is not stable over time, notably over the several weeks or even months that are needed in order to transfer the fluoropolymer composition from the production plant to the end user's warehouse(s).

As a consequence, the Applicant faced the problem of providing a composition comprising a fluoropolymer capable of maintaining the same pH value over weeks.

The Applicant surprisingly found that the above mentioned technical problem can be solved by the composition according to the present invention.

Thus, in a first aspect, the present invention relates to a composition [composition (CF)] comprising an aqueous medium, at least one VDF-based polymer [polymer (VDF)] and at least one salt [compound (S)] comprising an alkaline metal cation and an anion selected from of hydrogencarbonate and hydrogenphosphate.

The Applicant surprisingly found that composition (CF) according to the present invention is capable of maintaining an unaltered pH value for several weeks, even upon exposure to a temperature higher than room temperature (i.e., around 25° C.).

As it will be apparent to those skilled in the art, said compound (pH-S) comprises at least one proton (H⁺).

### DESCRIPTION OF EMBODIMENTS

As used within the present description and in the following claims:
the use of parentheses around symbols or numbers identifying the formulae, for example in expressions like “polymer (P)”, etc., has the mere purpose of better distinguishing the symbol or number from the rest of the text and, hence, said parenthesis can also be omitted;
the terms “1,1-difluoroethylene”, “1,1-difluoroethene” and “vinylidene fluoride” are used as synonyms;
the terms “poly-(1,1-difluoroethylene)” and “polyvinylidene fluoride” are used as synonyms;
the expression “(semi)crystalline polymer” is intended to indicate a polymer having a heat of fusion of more than 1 J/g, more preferably from 35 J/g to 1 J/g, even more preferably from 15 to 5 J/g, when measured by Differential Scanning Calorimetry (DSC) at heating rate of 10°/min, according to ASTM D-3418;
the expression “polymer (VDF) comprising recurring units derived from 1,1-difluoroethylene” is intended to indicate that polymer (F) is obtained by reacting together at least 1,1-difluoroethylene monomers, via a suitable reaction;
the term “dispersion (D)” is intended to indicate an aqueous dispersion comprising particles of at least one polymer (F), said particles having an average size of less than 1 μm, as measured according to ISO 13321, and hence the terms “dispersion (D)” and “latex” are intended as synonyms.

Preferably, the alkaline metal cation is selected from the group consisting of Li⁺, Na⁺ and K⁺ cations, more preferably the alkaline metal cation is Na⁺ cation.

Preferably, composition (CF) according to the present invention comprises said compound (S) in an amount of from 30 to 500 millimoles (mmol) per liter of composition (SC).

Advantageously, composition (CF) is free from said compound (S) before the same is added to the composition in order to stabilize the pH value.

However, composition (CF) may contain a base compound, such as for example ammonia or another compound bearing an amine function or mixtures thereof.

Polymer (VDF) according to the present invention is preferably a crystalline or partially crystalline polymer.

According to a first preferred embodiment, said polymer (VDF) is a homo-polymer of VDF [polymer (VDF_{H})], i.e., it essentially consists of recurring units derived from VDF (also referred to as 1,1-difluoroethylene).

According to this embodiment, said polymer (VDF_{H}) comprises an amount of recurring units derived from VDF up to 100 mol. %.

Said polymer (VDF_{H}) may still comprise other moieties such as defects, end-groups and the like, which do not affect nor impair its physical-chemical properties.

Advantageously, said polymer (VDF_{H}) is crystalline.

According to another embodiment, said polymer (VDF) is a copolymer of VDF [polymer (VDF_{C})], i.e. it comprises recurring units derived from VDF (also referred to as 1,1-difluoroethylene) and recurring units derived from at least one fluorinated monomer different from VDF [monomer (F)].

Said monomer (F) can be either a hydrogenated monomer [monomer (F_{H})] or a fluorinated monomer [monomer (F_{F})].

By the term “hydrogenated monomer [monomer (F_{H})]”, it is hereby intended to denote an ethylenically unsaturated co-monomer free of fluorine atoms.

Non-limitative examples of suitable monomers (F_{H}) include, notably, ethylene; propylene; vinyl monomers such as vinyl acetate; styrene monomers, like styrene and p-methylstyrene; and (meth)acrylic monomer [monomer (MA)].

Said monomer (MA) preferably complies with formula:

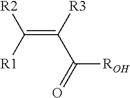

wherein
each of R1, R2, R3, equal or different from each other, is independently an hydrogen atom or a C₁-C₃ hydrocarbon group, and R_{OH} is a hydroxyl group or a C₁-C₅ hydrocarbon moiety comprising at least one hydroxyl group

Non limitative examples of said monomer (MA) are notably acrylic acid, methacrylic acid, hydroxyethyl (meth)acrylate, hydroxypropyl(meth)acrylate; hydroxyethylhexyl(meth)acrylates.

Said monomer (MA) is more preferably selected among:
hydroxyethylacrylate (HEA) of formula:

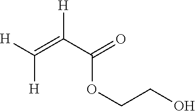

2-hydroxypropyl acrylate (HPA) of either of formulae:

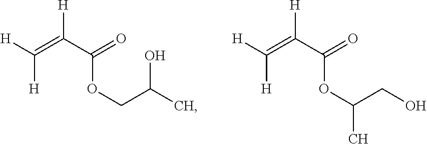

acrylic acid (AA) of formula:

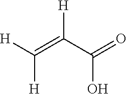

and mixtures thereof.

More preferably, said monomer (MA) is AA and/or HEA, even more preferably is AA.

Determination of the amount of monomer (MA) recurring units in polymer (VDF) can be performed by any suitable method. Mention can be notably made of acid-base titration methods, well suited e.g. for the determination of the acrylic acid content, of NMR methods, adequate for the quantification of said monomers (MA) comprising aliphatic hydrogens in side chains (e.g. HPA, HEA), of weight balance based on total fed monomer (MA) and unreacted residual monomer (MA) during polymer (VDF) manufacture.

When present, said polymer (VDF) comprises at least 0.1, more preferably at least 0.2% moles of recurring units derived from said monomer (MA).

Preferably, polymer (F) comprises at most 10, more preferably at most 7.5% moles, even more preferably at most 5% moles, most preferably at most 3% moles of recurring units derived from said monomer (MA).

By the term “fluorinated monomer [monomer (F_{F})]”, it is hereby intended to denote an ethylenically unsaturated co-monomer comprising at least one fluorine atom.

In a preferred embodiment, said monomer (F) is monomer (F_{F}).

Non-limitative examples of suitable monomers (F_{F}) include, notably, the followings:

(a) C₂-C₈ fluoro- and/or perfluoroolefins, such as tetrafluoroethylene (TFE), hexafluoropropylene (HFP), pentafluoropropylene and hexafluoroisobutylene;
(b) C₂-C₈ hydrogenated monofluoroolefins, such as vinyl fluoride, 1,2-difluoroethylene and trifluoroethylene;
(c) CH₂═CH—R_{f0}, wherein R_{f0} is a C₁-C₆ perfluoroalkyl group;
(d) chloro- and/or bromo- and/or iodo-C₂-C₆ fluoroolefins such as chlorotrifluoroethylene (CTFE);
(e) CF₂═CFOR_{f1}, wherein R_{f1} is a C₁-C₆ fluoro- or perfluoroalkyl group, e.g. —CF₃, —C₂F₅, —C₃F₇;
(f) CF₂═CFOX₀, wherein X₀ is a C₁-C₁₂ oxyalkyl group or a C₁-C₁₂ (per)fluorooxyalkyl group having one or more ether groups, e.g. perfluoro-2-propoxy-propyl group;
(g) CF₂═CFOCF₂OR_{f2}, wherein R_{f2} is a C₁-C₆ fluoro- or perfluoroalkyl group, e.g. —CF₃, —C₂F₅, —C₃F₇ or a C₁-C₆ (per)fluorooxyalkyl group having one or more ether groups, e.g. —C₂F₅—O—CF₃;
(h) (per) fluorodioxoles of formula

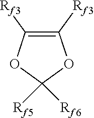

wherein each of R_{f3}, R_{f4}, R_{f5} and R_{f6}, equal to or different from each other, is independently a fluorine atom, a C₁-C₆ fluoro- or per(halo)fluoroalkyl group, optionally comprising one or more oxygen atoms, e.g. —CF₃, —C₂F₅, —C₃F₇, —OCF₃, —OCF₂CF₂OCF₃.

Most preferred monomers (F_{F}) are tetrafluoroethylene (TFE), trifluoroethylene (TrFE), chlorotrifluoroethylene (CTFE), hexafluoropropylene (HFP), perfluoromethyl vinyl ether (PMVE), perfluoropropyl vinyl ether (PPVE) and vinyl fluoride. HFP being particularly preferred.

Preferably, said polymer (VDF_{C}) comprises an amount of recurring units derived from VDF of at least 85.0 mol. %, preferably of at least 86.0 mol. %, more preferably at least 87.0 mol. %, so as not to impair the excellent properties of vinylidene fluoride resin, such as chemical resistance, weatherability, and heat resistance. For instance, when said crystalline or partially crystalline polymer (VDF_{C}) comprises an amount of recurring units derived from VDF of less than 85.0 mol. %, it cannot be used for formulating coating compositions for making composite separators for batteries, as the corresponding polymer would dissolve in the liquid solvent used as electrolyte liquid phase.

According to certain embodiments, polymer (VDF) consists essentially of recurring units derived from VDF, and of recurring units derived from said monomer (MA).

According to other embodiments, polymer (VDF) consists essentially of recurring units derived from VDF, of recurring units derived from HFP and of recurring units derived from said monomer (MA).

Polymer (VDF) may still comprise other moieties such as defects, end-groups and the like, which do not affect nor impair its physic-chemical properties.

Suitable polymers (VDF) are commercially available by Solvay Specialty Polymers Italy S.p.A. under the tradename Solef® PVDF.

Preferably, said composition (CF) is in the form of a dispersion [dispersion (D)].

Preferably, said polymer (VDF) in the composition (CF) according to the present invention is in the form of particles.

Preferably, the particles of said polymer (VDF) possess a primary particle average size of less than 1 μm.

For the purpose of the present invention, the term “primary particles” is intended to denote primary particles of polymer (VDF) deriving directly from aqueous emulsion polymerization process, without isolation of the polymer from the emulsion. Primary particles of polymer (VDF) are thus to be intended distinguishable from agglomerates (i.e. collection of primary particles), which might be obtained by recovery and conditioning steps of such polymer manufacture such as concentration and/or coagulation of aqueous latexes of the polymer (VDF) and subsequent drying and homogenization to yield the respective powder. As explained above, dispersion (D) according to the present invention is thus distinguishable from an aqueous slurry that can be prepared by dispersing powders of a polymer in an aqueous medium. The average particle size of powders of a polymer or copolymer dispersed in an aqueous slurry is typically higher than 1 μm, as measured according to ISO 13321.

Preferably, the primary particles average size of the particles of polymer (VDF) in said dispersion (D) is above 50 nm, more preferably above 100 nm, even more preferably above 150 nm as measured according to ISO 13321.

Preferably, the primary particles average size is below 600 nm, more preferably below 400 nm and even more preferably below 350 nm as measured according to ISO 13321.

More preferably, the primary particles average size of the particles of polymer (VDF) in said dispersion (D) is from 130 nm to 280 nm as measured according to ISO 13321.

Preferably, dispersion (D) is substantially free from fluorinated surfactants.

The expression “substantially free” in combination with the amount of fluorinated surfactants in dispersion (D) is to be meant to exclude the presence of any significant amount of said fluorinated surfactants, e.g. requiring the fluorinated surfactants to be present in an amount of less than 1 ppm, with respect to the total weight of dispersion (D).

Said aqueous medium is advantageously water, more preferably deionized water.

If necessary or required by the final use or even by the method for its manufacture, said composition (CF) can comprise further ingredients or adjuvants.

Typically, said further ingredients or adjuvants are selected in the group comprising radical initiator(s), oxidizing agent(s),

While the choice of the radical initiator is not particularly limited, it is understood that radical initiators suitable for an aqueous emulsion polymerization process are compounds capable of initiating and/or accelerating the polymerization process and include, but are not limited to, persulfates, such as sodium, potassium and ammonium persulfates; organic peroxide, including notably alkyl peroxide, dialkyl peroxide (such as di-tert-butylperoxide—DTBP), diacyl-peroxide, peroxydicarbonates (such as di-n-propyl peroxydicarbonate and diisopropyl peroxydicarbonate), peroxy esters (such as tert-amyl peroxypivalate, tertbutyl peroxypivalate and succinic acid peroxide); and mixtures thereof.

The radical initiator may optionally comprise an azo initiator, such as for example 2,2′-azobis(2-methylpropionamidine)dihydrochloride.

The radical initiator may comprise a redox system. By “redox system” is meant a system comprising an oxidizing agent, a reducing agent and optionally, an electron transfer medium.

Oxidizing agents include, for example, persulfate salts; peroxides, such as hydrogen peroxide; hydroperoxides such as tertbutyl hydroperoxide and cumene hydroperoxide; and oxidizing metal salts such as, for example, ferric sulfate. Reducing agents include, for example, sodium formaldehyde sulfoxylate, sodium and potassium sulfite, ascorbic acid, bisulfite, metabisulfite, and reduced metal salts.

Composition (CF) according to the present invention can be advantageously used to provide a coating onto a separator and/or as a binder for the manufacture of the anode of an electrochemical cells.

By the term “separator”, it is hereby intended to denote a porous substrate, preferably a polymeric material, which electrically and physically separates electrodes of opposite polarities in an electrochemical cell and is permeable to ions flowing between them.

Non-limitative examples of suitable porous substrates useful to provide the separator include, notably, porous membranes made from inorganic, organic and naturally occurring materials, and in particular made from nonwoven fibers (cotton, polyamides, polyesters, glass), from polymers (polyethylene, polypropylene, poly(tetrafluoroethylene), poly(vinyl chloride), and from certain fibrous naturally occurring substances (e.g. asbestos).

By the term “electrochemical cell”, it is hereby intended to denote an electrochemical cell comprising a positive electrode, a negative electrode and a liquid electrolyte, wherein a monolayer or multilayer separator is adhered to at least one surface of one of said electrodes.

Non-limitative examples of electrochemical cells include, notably, batteries, preferably secondary batteries, and electric double layer capacitors.

For the purpose of the present invention, by “secondary battery” it is intended to denote a rechargeable battery. Non-limitative examples of secondary batteries include, notably, alkaline or alkaline-earth secondary batteries, more preferably lithium batteries.

The composite separator obtained from the method of the invention is advantageously an electrically insulating composite separator suitable for use in an electrochemical cell.

Composition (CF) according to the present invention can be applied onto the porous support by any suitable method, such as notably casting, spray coating, roll coating, doctor blading, slot die coating, gravure coating, ink jet printing, spin coating and screen printing, brush, squeegee, foam applicator, curtain coating, vacuum coating.

The expression “anode of an electrochemical cells” is intended to indicate the negative electrode. The negative electrode comprises particles of at least one active electrode compound, herein after referred to as active anode compound [compound (E-)].

Said compound (E-) is preferably selected from:
graphitic carbons able to intercalate lithium, typically existing in forms such as powders, flakes, fibers or spheres (for example, mesocarbon microbeads) hosting lithium;
lithium metal;
lithium alloy compositions, including notably those described in U.S. Pat. No. 6,203,944 (3M INNOVATIVE PROPERTIES CO.) and/or in WO 00/03444 (MINNESOTA MINING AND MANUFACTURING CO.);
lithium titanates, generally represented by formula Li₄Ti₅O₁₂; these compounds are generally considered as “zero-strain” insertion materials, having low level of physical expansion upon taking up the mobile ions, i.e. Li⁺;
lithium-silicon alloys, generally known as lithium silicides with high Li/Si ratios, in particular lithium silicides of formula Li_{4.4}Si;
lithium-germanium alloys, including crystalline phases of formula Li_{4.4}Ge.

The anode may contain additives as will be familiar to those skilled in the art. Among them, mention can be made notably of carbon black, graphene or carbon nanotubes. As will be appreciated by those skilled in the art, the negative electrode may be in any convenient form including foils, plates, rods, pastes or as a composite made by forming a coating of the negative electrode material on a conductive current collector or other suitable support.

In order to obtain the anode of an electrochemical cell, said composition (CF) and said particles of said compound (E-) are contacted, thus obtaining a composition comprising particles of said compound (E-) in admixture with composition (CF).

Should the disclosure of any patents, patent applications, and publications which are incorporated herein by reference conflict with the description of the present application to the extent that it may render a term unclear, the present description shall take precedence.

The present invention will be now described in more detail with reference to the following examples, whose purpose is merely illustrative and not limitative of the scope of the invention.

### Experimental Section

Materials:

Solef® PVDF latex XPH-925 was obtained from Solvay Specialty Polymers Italy S.p.A.

Sodium hydrogen carbonate (CAS 144-55-8; assay>=99.7%), ammonia were obtained from Sigma Aldrich

Preparation of the Samples

Two Samples of Solef® PVDF latex XPH-925 were mixed with 40 mL of ammonia (29 wt. %) until their pH was about 8.

Then, the samples thus obtained were mixed with different amounts of an aqueous solution of sodium hydrogen carbonate (concentration of 90 g/L) and stored first at 50° C. for several weeks as reported in the following Table 1 and then at room temperature for 10 weeks.

The pH was then evaluated using pHmeter SevenCompact™ S220 from METTLER TOLEDO equipped with Ag/AgCl electrode.

As comparison, a third Sample of Solef® PVDF latex XPH-925 was mixed with 40 mL of ammonia (29 wt. %) until its pH was about 8 and stored at 50° C. for several weeks as reported in the following Table 1.

The results obtained for all the Samples are reported in the Table 1 herein below.

TABLE 1

| | | NaHCO₃ | No. of weeks | | |
|---|---|---|---|---|---|
| Sample | Initial pH | (mmol/L) | 50° C. | RT | Final pH |
| 1 | 8.04 | 150 | 14 | 10 | 8.10 |
| 2 | 8.17 | 180 | 12 | 10 | 7.90 |
| 3C(*) | 8.10 | — | 2 | — | 5.86 |

(*)comparative
RT = room temperature about 25° C.

1. A composition (CF) comprising an aqueous medium, at least one polymer (VDF), wherein polymer (VDF) is a VDF-based polymer, and at least one compound (S), wherein compound (S) is at least one salt comprising an alkaline metal cation and an anion selected from of hydrogencarbonate and hydrogenphosphate,
wherein composition (CF) is in the form of a dispersion (D).

2. The composition (CF) according to claim 1, wherein said compound (S) is in an amount of from 30 to 500 millimoles (mmol) per liter of said composition (CF).

3. The composition (CF) according to claim 1, wherein said polymer (VDF) is a homo-polymer consisting essentially of recurring units derived from 1,1-difluoroethylene.

4. The composition (CF) according to claim 1, wherein said polymer (VDF) is a copolymer comprising recurring units derived from 1,1-difluoroethylene and recurring units derived from at least one monomer (F), wherein monomer (F) is at least one monomer different from 1,1-difluoroethylene.

5. The composition (CF) according to claim 4, wherein said monomer (F) is a hydrogenated monomer selected from ethylene; propylene; vinyl monomers such as vinyl acetate; styrene monomers, like styrene and p-methylstyrene; and (meth)acrylic monomer (MA).

6. The composition (CF) according to claim 5, wherein said monomer (MA) complies with the following formula: 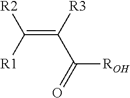
wherein
each of R1, R2, R3, equal or different from each other, is independently a hydrogen atom or a C₁-C₃ hydrocarbon group, and
R_{OH} is a hydroxyl group or a C₁-C₅ hydrocarbon moiety comprising at least one hydroxyl group.

7. The composition (CF) according to claim 4, wherein said monomer (F) is a fluorinated monomer selected from:
(a) C₂-C₈ fluoro- and/or perfluoroolefins;
(b) C₂-C₈ hydrogenated monofluoroolefins;
(c) CH₂═CH—R_{f0}, wherein R_{f0} is a C₁-C₆ perfluoroalkyl group;
(d) chloro- and/or bromo- and/or iodo-C₂-C₆ fluoroolefins;
(e) CF₂═CFOR_{f1}, wherein R_{f1} is a C₁-C₆ fluoro- or perfluoroalkyl group;
(f) CF₂═CFOX₀, wherein X₀ is a C₁-C₁₂ oxyalkyl group or a C₁-C₁₂ (per)fluorooxyalkyl group having one or more ether groups;
(g) CF₂═CFOCF₂OR_{f2}, wherein R_{f2} is a C₁-C₆ fluoro- or perfluoroalkyl group or a C₁-C₆ (per)fluorooxyalkyl group having one or more ether groups;
(h) (per) fluorodioxoles of formula: 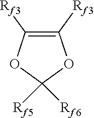
wherein each of R_{f3}, R_{f4}, R_{f5} and R_{f6}, equal to or different from each other, is independently a fluorine atom, a C₁-C₆ fluoro- or per(halo)fluoroalkyl group, optionally comprising one or more oxygen atoms.

8. The composition (CF) according to claim 7, wherein said monomer (F) is a fluorinated monomer selected from the group consisting of, tetrafluoroethylene (TFE), trifluoroethylene (TrFE), chlorotrifluoroethylene (CTFE), hexafluoropropylene (HFP), perfluoromethyl vinyl ether (PMVE), perfluoropropyl vinyl ether (PPVE) and vinyl fluoride.

9. The composition (CF) according to claim 1, wherein said polymer (VDF) is in the form of particles.

10. The composition (CF) according to claim 9, wherein the particles of said polymer (VDF) possess a primary particle average size of less than 1 μm, as measured according to ISO 13321.

11. The composition (CF) according to claim 10, wherein the particles of said polymer (VDF) possess a primary particle average size of greater than 50 nm and less than 600 nm, as measured according to ISO 13321.

12. The composition (CF) according to claim 11, wherein the particles of said polymer (VDF) possess a primary particle average size of from 130 nm to 280 nm as measured according to ISO 13321.

13. A separator for an electrochemical cell comprising a porous substrate at least partially coated with the composition (CF) as defined in claim 1.

14. An anode for an electrochemical cell comprising particles of at least one active anode compound in admixture with composition (CF) as defined in claim 1.

15. The composition (CF) according to claim 7, wherein said monomer (F) is a fluorinated monomer selected from the group consisting of:
(a) tetrafluoroethylene (TFE), hexafluoropropylene (HFP), pentafluoropropylene and hexafluoroisobutylene;
(b) vinyl fluoride, 1,2-difluoroethylene and trifluoroethylene;
(c) CH₂═CH—R_{f0}, wherein R_{f0} is a C₁-C₆ perfluoroalkyl group;
(d) chlorotrifluoroethylene (CTFE);
(e) CF₂═CFOR_{f1}, wherein R_{f1} is a —CF₃, —C₂F₅, or —C₃F₇;
(f) CF₂═CFOX₀, wherein X₀ is a perfluoro-2-propoxy-propyl group;
(g) CF₂═CFOCF₂OR_{f2}, wherein R_{f2} is —CF₃, —C₂F₅, —C₃F₇ or —C₂F₅—O—CF₃; and
(h) (per) fluorodioxoles of formula: 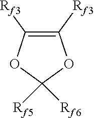
wherein each of R_{f3}, R_{f4}, R_{f5} and R_{f6}, equal to or different from each other, is independently —F, —CF₃, —C₂F₅, —C₃F₇, —OCF₃, or —OCF₂CF₂OCF₃.

16. The composition (CF) according to claim 11, wherein the particles of said polymer (VDF) possess a primary particle average size of greater than 100 nm and less than 400 nm, as measured according to ISO 13321.

17. The composition (CF) according to claim 11, wherein the particles of said polymer (VDF) possess a primary particle average size of greater than 150 nm and less than 350 nm, as measured according to ISO 13321.
